(19) United States
(12) Patent Application Publication
(10) Pub. No.: US 2003/0223238 A1
(43) Pub. Date: Dec. 4, 2003

(54) Foaming molded lampshade

(76) Inventors: Yuan-Shun Hsu, Chu-Pei City (TW); Eisho Hayashi, Tokyo (JP)

Correspondence Address: BIRCH STEWART KOLASCH & BIRCH, PO BOX 747, FALLS CHURCH, VA, 22040-0747, US

(21) Appl. No.: 10/160,099

(22) Filed: Jun. 4, 2002

(51) Int. Cl. F21V 3/00; F21V 5/00

(52) U.S. Cl. 362/255; 362/326; 362/363

(57) ABSTRACT

A foaming molded lampshade includes a plurality of refraction units with different refractive indexes formed by hot melting foaming molding and a connection unit integrally formed with the lampshade at one end of the lampshade by molding, and a lamp coupling on the connection unit of the lampshade. Lights emitted by the lamp scattering around the lampshade and through different hot-melt medium elements of the refraction units generating brilliant and fascinating visual effects with bubbles similar to arrays of universe constellations.

### FIELD OF THE INVENTION

The present invention relates to a foaming molded lampshade and particularly to a foaming molded lampshade made by hot melting foaming molding to form media of different refractive indexes.

### BACKGROUND OF THE INVENTION

In the past, it is a common practice to decorate sites of outdoor parties or street events where festivals and celebrations are conducted with ornamental lights. In order to generate brilliant visual effect, the ornamental lights generally include a plurality of sockets connecting by power cords in series, and the sockets are coupled with lamps of different colors. When the ornamental lights are plugged to electric power, the lamps instantly emit colorful lights to pass through the transparent lamp shells to decorate the sites of wedding parties, celebration events, conventions or dancing parties, etc.

Although the ornamental lights mentioned above can foster joyful atmosphere and create amusing and entertaining effect for the parties and events, there are still many ornamental lights do not have transparent objects to refract light projections. Lights directly emit in a scattering manner from the lamps, and often become too strong and irritating, and cannot generate the desired atmosphere.

Furthermore, the lamps mounted on the ornamental lights usually are made from brittle glass and are naked and exposed. Transportation and carrying must be very careful, otherwise the lamps are prone to hit one another and easily shattered. Moreover, on the sites where the ornamental lights are installed, strong winds could cause strings of ornamental lights swinging and the sockets wobbling. It also tends to shatter the lamps. The shattered lamps not only cost money but also create the risk of injuring people.

### SUMMARY OF THE INVENTION

Therefore the primary object of the invention is to provide a foaming molded lampshade made by hot melting foaming molding to form media of different refractive indexes that can focus and reflect lights to generate special visual effects similar to arrays of universe constellations and produce colorful and fascinating results.

In order to achieve the foregoing object, the foaming molded lampshade of the invention is mainly coupling with a lamp of various styles. Inside the lampshade, there is a plurality of refraction units of different refractive indexes made by hot melting foaming molding. The lampshade further has a connection unit integrally formed with the lampshade by molding for coupling the lamp. The foaming molded lampshade thus made has a simple structure and can generate brilliant refractive effects.

Another object of the invention is to provide a hot-melt resistant connection unit made by molding to enable light sources to project the lampshade to generate a clear lamp image and create desired visual effects.

Yet another object of the invention is to provide a foaming molded lampshade that is easy to assemble or disassemble to save installation time.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is a cross section taken along line 2-2 in FIG. 1.

FIG. 3 is a schematic view of the invention in a use condition.

FIG. 4 is schematic view of the invention in another use condition.

### DESCRIPTION OF THE PREFERRED EMBODIMENT

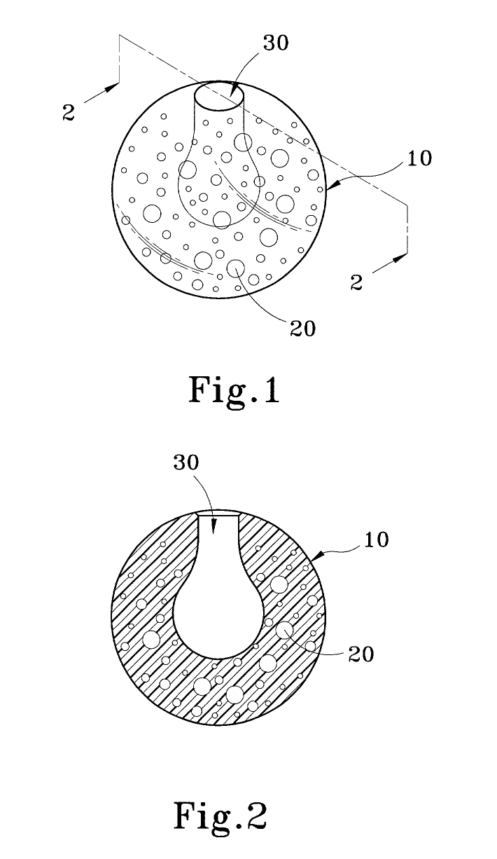

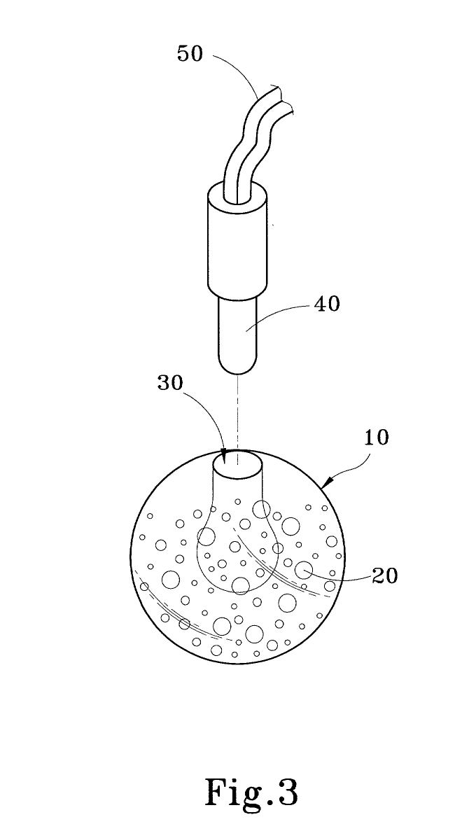

Referring to FIGS. 1, 2 and 3, the foaming molded lampshade 10 of the invention mainly aims to couple with a lamp 40 of various styles, such as lamp bulbs, fluorescent lamps, ornamental lamps, etc. The lamp 40 includes light emitting diodes connecting by power cords 50 in series (as shown in FIG. 3) and in a cross fashion. The structure is easy to assemble or disassemble.

The lampshade 10 is made from a hot-melt resistant or a high temperature resistant material with flexible property, such as polyvinyl chloride (PVC) or polystyrene (PS). In the lampshade 10, there is a plurality of refraction units 20 with different refractive indexes formed by hot melting foaming molding. On an upper end of the lampshade 10, there is a connection unit 30 integrally formed with the lampshade 10 by molding for coupling with the lamp 40. The foaming molded lampshade 10 thus made can save installation time of the lamp 40, and also is easy to assemble or disassemble.

Referring to FIG. 2, in order to provide brilliant lights and crystalline visual effect, the refraction units 20 are formed with curvatures of different incident angles and refractive angles, and are positioned in various styles. Hence with the refraction units 20 integrally formed inside the lampshade 10, light sources may be focused and absorbed. In order to produce clear image of the lamp 40, the connection unit 30 must be made from a hot-melt resistant or a high temperature resistant material so that after the lamp 40 is mounted to the connection unit 30, the connection unit 30 remains intact without causing blurred images after heating by projection of the strong lights. With the lamp 40 mounting in the connection unit 30, emitting light scatter around in the lampshade 10, and through different hot melt medium elements of the refraction units 20, brilliant lights and fascinating visual effects may be generated.

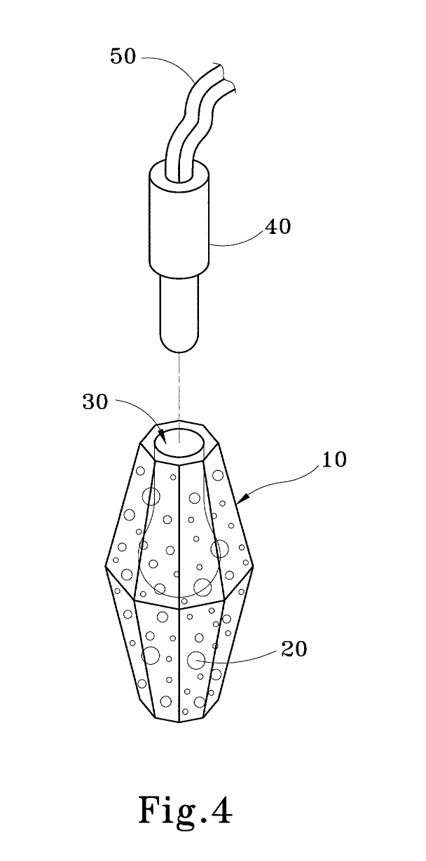

Referring to FIGS. 3 and 4, when in use, the invention is connected in series like a conventional light. It is known in the art, details are omitted. The following depicts the unique features of the invention. First, couple the connection unit 30 of the arched lampshade 10 with the lamp 40; the lamp 40 projects versatile and colorful lights to the lampshade 10; the refraction units 20 located around the lampshade 10 are light source media that have the property of absorbing light in a stable manner, and the connection unit 30 is hot-melt resistant or high temperature resistant, the light source media in the refraction units 20 are hot-melted in advance so that lights of different incident angles may be projected to the refraction units 20 and focus; then the processed light sources discussed above project to the lampshade 10 which is formed either in transparent, semi-transparent or smoke finished manner, and through different reflection angles, the resulting lights scatter out through the lampshade 10. A clear image of the lamp 40 can be obtained, and a brilliant visual effect also is generated. In addition, the lamp 40 mounted to the lampshade 10 may be made in various forms such as a symmetrical polygon, a polygon, an irregular shape, etc. Through multiple refraction optical paths, a fascinating visual effect similar to arrays of universe constellation may be generated.

In summary, the invention provides a simple structure that makes assembly and disassembly easier, and saves installation time. It effectively overcomes the disadvantages incurred to conventional ornamental lights.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A foaming molded lampshade, comprising:
a lampshade including a plurality of refraction units with different refractive indexes formed by hot melting foaming molding and a connection unit integrally formed with the lampshade at one end of the lampshade by molding; and
a lamp coupling with the connection unit of the lampshade and connecting in series to a plurality of crossed power cords such that lights emitted by the lamp scattering around the lampshade and through different hot-melt medium elements of the refraction units generating brilliant and fascinating visual effects with bubbles similar to arrays of universe constellations.

2. The foaming molded lampshade of claim 1, wherein the lampshade is selectively made from a hot-melt resistant or a high temperature resistant material with flexible property including polyvinyl chloride (PVC) or polystyrene (PS).

3. The foaming molded lampshade of claim 1, wherein the refraction units have incident angles and refractive angles of different curvatures, and have various styles and are integrally formed with the lampshade.

4. The foaming molded lampshade of claim 1, wherein the connection unit is selectively made from a hot-melt resistant or a high temperature resistant material to withstand heat resulting from direct projection of a strong light source to prevent damage.

5. The foaming molded lampshade of claim 1, wherein the lampshade is formed in a shape selecting from the group consisting of an arched shape, a symmetrical polygon, a polygon, or an irregular shape to generate the desired visual effects.

6. The foaming molded lampshade of claim 1, wherein the lampshade is selectively formed in transparent, semi-transparent or smoke finished.

7. The foaming molded lampshade of claim 1, wherein the lamp is a light emitting diode.
